(19) United States
(12) Patent Application Publication
(10) Pub. No.: US 2014/0174893 A1
(43) Pub. Date: Jun. 26, 2014

(54) DEVICE FOR FILLING CONTAINERS WITH FOOD PRODUCTS

(71) Applicant: Martin Junk, Tholey (DE)

(72) Inventor: Martin Junk, Tholey (DE)

(73) Assignee: Hamba Filltec GmbH & Co. KG, Saarbruecken (DE)

(21) Appl. No.: 14/046,980

(22) Filed: Oct. 6, 2013

(30) Foreign Application Priority Data
Oct. 16, 2012 (DE) 102012020307.1

(51) Int. Cl. B65B 43/42; B65G 35/08

(52) U.S. Cl. CPC B65B 43/42; B65G 35/08
USPC 198/867.01

(57) ABSTRACT

A device for filling containers with low viscosity to pasty food products, comprising: support elements that are run in a feed direction along an upper element, a first side element, a lower element and a second side element through the device in an endless manner, wherein the support elements are run through the device in a chainless manner, wherein the support elements are moved by a feed device between the upper element and the lower element, wherein the support elements include receivers for containers, wherein the containers are supported in the support elements along operating stations, wherein a magazine is arrangeable at least at one of the side elements and the magazine is used for introducing additional support elements from the magazine into the device and/or for receiving support elements arranged in the device. The device facilitates a quick and simple format change.

### RELATED APPLICATIONS

This application claims priority from and incorporates by reference German patent application number DE 10 2012 020 307.1 filed on Oct. 16, 2012.

### FIELD OF THE INVENTION

The invention relates to a device for filling containers with liquid to pasty food products, wherein
support elements are run in feed direction along an upper element, a first side element, a lower element and a second side element in an endless manner through the device,
the support elements are run through the device in a chainless manner,
the support elements are moved by a feed device between the upper element and the lower element,
the support elements have receivers for the containers
the containers are supported in the support elements along operating stations.

### BACKGROUND OF THE INVENTION

Devices of this general type for filling containers with food products are known in the art from various patent documents. Reference is made for example to EP 1 495 997 B1, WO 2011/072628 and the unpublished applications of the applicant DE 10 2011 10 31 522, DE 10 2011 10 32 561, and DE 10 2011 10 31 549

The recited documents exclusively disclose devices with so-called chainless drive, which are different from the more common devices for filling containers with food products with so-called chain drives. In devices with chain drives, the individual support elements are connected with one another with a drive chain. This means the support elements are movement coupled through suitable attachments with a drive or propulsion chain. This chain in turn is moved by a drive motor so that the support elements are moved through the device in an endless loop. A chainless drive is therefore defined in the art as a drive which operates without one or plural drive or propulsion chains that connect the support elements with one another.

Chainless devices or devices with a chainless drive (both shall be used synonymously herein) have the essential advantage that the support elements after one position calibration at the particular operating stations like sterilization device sealing device filling device, etc. are run through the device with permanently exact position control. The chain elongation that occurs in a chain drive and the associated changing positioning of the support elements relative to the operating stations is safely prevented. Furthermore, in devices with chainless drive, numerous components can be configured less solid since the chains with their inertias, their respective sprockets and support bars and numerous additional necessary static components are not required anymore.

In devices for filling containers with food products, no matter whether they have a chain drive or a chainless drive, it is typical to replace support elements with receivers for a first container type with support elements with different receivers for a second container type in order to be able to process different products or packaging sizes with the same machine. This process is typically designated as format change and is rather difficult to perform in chain operated devices. Since the support elements are individually movement coupled with the chain, attachments have to be disengaged, the support elements need to be exchanged and subsequently attached again. Thereafter, the support elements have to be re-centered with respect to the operating station in any case.

The format change can theoretically be performed in a simple manner for chainless devices since the complicated disengagement and reattachment of the support elements on a drive chain can be omitted.

### BRIEF SUMMARY OF THE INVENTION

Since chainless devices for filling containers with food products have so far only been discussed in theory or may have reached prototype status, it is an object of the invention to provide a device of this general type in which a format change can be performed in a quick and simple manner.

The object is achieved by A device for filling containers with low viscosity to pasty food products, comprising: support elements that are run in a feed direction along an upper element, a first side element, a lower element and a second side element through the device in an endless manner, wherein the support elements are run through the device in a chainless manner, wherein the support elements are moved by a feed device between the upper element and the lower element, wherein the support elements include receivers for containers, wherein the containers are supported in the support elements along operating stations, wherein a magazine is arrangeable at least at one of the side elements and the magazine is used for introducing additional support elements from the magazine into the device and/or for receiving support elements arranged in the device. The device facilitates a quick and simple format change.

Thus, the invention is based on the fact that the switching portions designated as side elements in which the support elements switch from the upper element into the lower element for example like in WO 2011/072628A1 are formed by a lifting or lowering device and the magazine is directly connectable to this lifting or lowering device. Thus, in the recited PCT application the upper element and the lower element are easily accessible so that inserting and also removing additional support elements is possible through simple insertion onto the running bars.

When differently configured side elements are used like for example in EP 14 95 997 B1 and illustrated in FIG. 12, 11, 10 or 9 it will become evident that the upper element and the lower element are not easily laterally accessible but the lifting devices for moving the support elements from the upper element into the lower element close the side elements. Since the support elements do not form a closed interconnection among one another for a chainless drive, the switching device can be removed in a simple manner for closed side elements according to EP1495997 B1, for example by providing quick connectors so that the magazine according to the invention is also useable for side elements that are configured in this manner.

The essential advantage of the magazine according to the invention is initially that it is arrangeable and attachable at the side element so that the support elements stored in the magazine are easily insertable into the upper element or the lower element. Since inserting a support element into one of the elements is required in almost any case and also requires removing another support element, the second essential advantage is that not only the new support elements required for the format change can be stored in the magazine but simultaneously also the support elements that have to be removed through the format change from one of the elements are insertable into the magazine.

It is an essential advantage when the magazine includes positioning members which cooperate with positioning members at the device in order to provide a correct orientation and arrangement of the magazine at the device since this can provide a frictionless insertion of the support elements into the elements and simultaneously a frictionless removal of the support elements from the elements.

It is furthermore provided that the magazine and the device include coupling members that respectively cooperate with one another which provide a position fixated arrangement of the magazine at the device. The position fixated arrangement of the magazine at the device provides that the magazine can not disengage and the format change can be performed frictionless.

In order to provide an orderly storage of the support elements it is provided that the magazine includes insertion elements for receiving and/or removing individual support elements.

It is furthermore provided that the insertion elements are arranged in is the magazine vertically moveable. This provides that after removing a support element form the magazine and receiving another support element in the magazine, the insertion elements that have been released through the removal are moved with a respective vertical movement to the respective element where receiving of a support element that has to be extracted from the device has to be performed. Simultaneously, an insertion element provided with a support element to be inserted is arranged at the element into which the new support elements are inserted.

A device is particularly advantageous which is characterized in that the insertion elements are moved like a paternoster elevator at a vertically arranged magazine support. This provides a recirculation of the insertion elements, so that a continuous insertion and removal of support elements is provided.

It is furthermore provided that the insertion elements and/or the support elements are supported in the magazine in a rotatable or pivotable manner.

Thus, it is provided in particular that the insertion elements and/or the support elements seated in the support elements are respectively rotated or pivoted in the upper and lower reversal by 180°.

In order to induce the pivot or rotation movement in a simple and reliable manner, it is provided that the magazine includes a control curve or slotted link controlling the pivot movement. The essential advantage of this mechanical control is that no separate control motors or control conduits have to be provided.

It is also provided that the magazine includes an ejection and/or pull in device, through which the support elements are transferred to the device or removed from the device. This provides that a format change can be performed in a fully automated manner.

It is also advantageously provided that the magazine and the device provide signal coupling for control signals and/or energy coupling, so that providing the magazine with energy and/or control signals is performed by the device. In this manner, it is provided that only one central control and only one central energy supply has to be provided for the format change.

Ultimately, it is provided for the insertion elements to include retaining elements to firmly anchor the support elements. This guarantees that the support elements are safely supported within the magazine.

It is also provided that the insertion elements are configured with running bar sections that are similar to the running bars on which the support elements are run through the upper element and/or the lower element. This facilitates particularly unproblematic and simple format change.

It is furthermore provided that the insertion elements are respectively provided with at least one spacer through which they are respectively supported at an adjacent insertion element.

Eventually, it is provided that the movements of the spacer and of the insertion element are coupled, at least with respect to the rotation and pivoting movement of each component.

Ultimately, it is provided that the rotation and pivoting movement of the insertion element and/or the support element during the lower reversal to be opposite to the rotating and pivoting movement in the upper reversal.

### BRIEF DESCRIPTION OF THE DRAWINGS

Further advantages a deeper understanding of the invention can be obtained from the following description of an embodiment with reference to drawing figures, wherein:

FIG. 1 illustrates a schematic overview of the device according to the invention without magazine;

FIG. 2 illustrates a view according to FIG. 1 with magazine before coupling with the device.

FIG. 3 illustrates the device according to FIG. 2 with inserted magazine; and

FIG. 4 illustrates the device according to FIG. 3 with inserted and fixated magazine and a transfer of a support element from the magazine to the device.

### DETAILED DESCRIPTION OF THE INVENTION

A device according to the invention is provided overall with the reference 10 with the drawing figures.

The device 10 is used for filling liquid to pasty food products into containers 11 which are run along non-illustrated work stations through the device 10 by support elements that are overall designated with the reference 12.

The device 10 itself includes a horizontally arranged upper element OT and a lower element UT arranged parallel to the upper element and below the upper element with reference to the support surface or set up plane of the device 10. Typically, the operating stations for processing the containers 11 are arranged above the upper element OT. However, there also are arrangements in which the operating stations are arranged between upper element and lower element and the containers 11 are typically processed in the lower element UT. Therefore, the upper element OT and the lower element UT can be designated as so-called main elements.

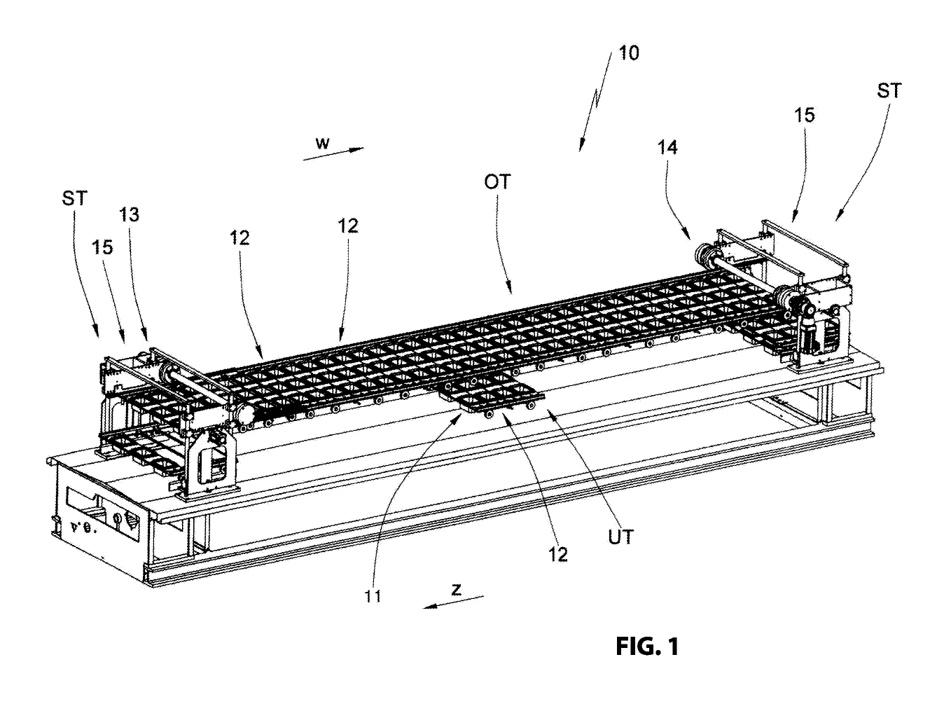

In order to provide circulation of the support elements 12 they are moved through side elements ST between the main elements. The support elements 12 run through the device 10 that is illustrated in FIG. 1, for example from the left side element ST which is provided with a drive 13 with a feed direction w to the right side element which includes a break device 14. The drive 13 and the break device 14 define the upper element OT.

The support elements 12 then move through the right side element ST which is configured as a lifting device 15 and described in more detail in DE 10 211 156 through an elevator type vertical movement into the lower element UT. From there the support element 12 is moved back in feed direction z to the left side element ST and is moved through the lifting device 15 included in the left side element and also described in DE 10 2011 103 256 vertically up to the level of the upper element OT and is integrated into the upper element OT at this location.

The device illustrated in FIG. 1 for filling containers with food products is a device with a so called chainless drive. This device is described in detail in WO 2011/072628 A1 owned by the applicant.

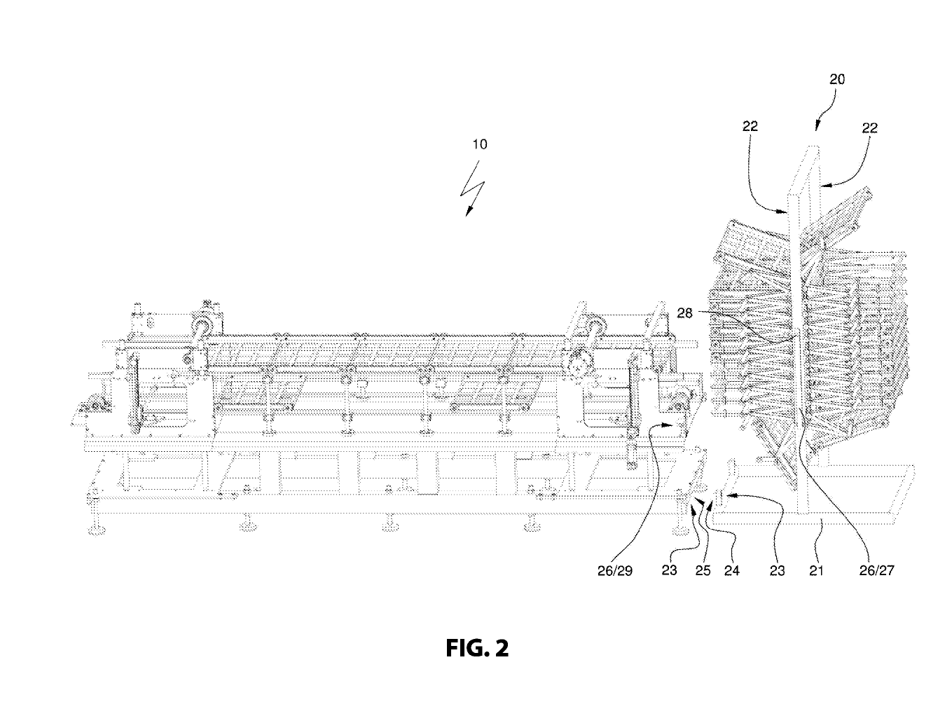

FIG. 2 now illustrates the device 10 according to FIG. 1 and additionally illustrates a magazine 20 which is used for removing and inserting support elements 12. The magazine 20 includes a support frame 21 close to the ground which is advantageously provided with rollers that are not illustrated in order to be able to move the magazine 20 in a simple manner. A pair of magazine supports 22 that are oriented vertically with respect to the setup plane or the support frame 21 is mounted at the support frame 21. The support frame 21 is provided with positioning members 23 configured as positioning pins 24 which are oriented toward the device 10. The device 10 includes corresponding positioning members 23 configured as positioning recesses 25. Furthermore the magazine 20 and also the device 10 respectively include coupling members 26. The magazine 20 includes a locking bar 27 which is pivotally arranged at a vertical support 22. The locking bar 27 includes a locking bar cut out 28 at its free end portion wherein the locking bar cut out interacts with a coupling member 26 configured as a locking pin 29 at the device.

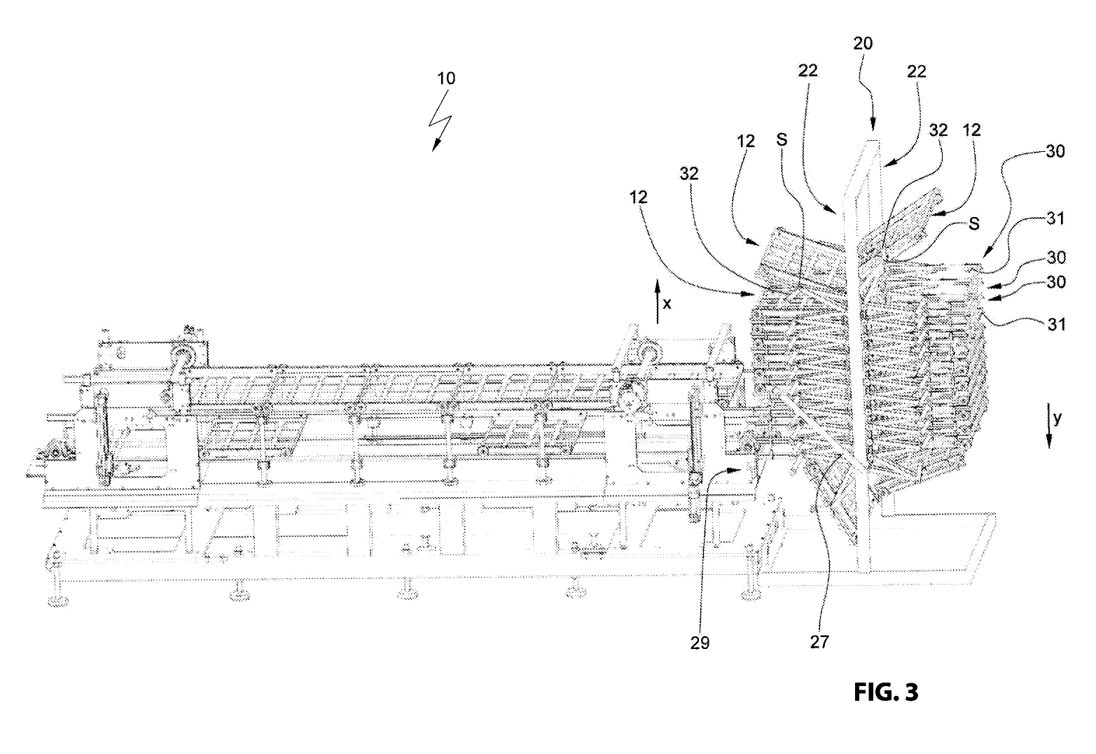

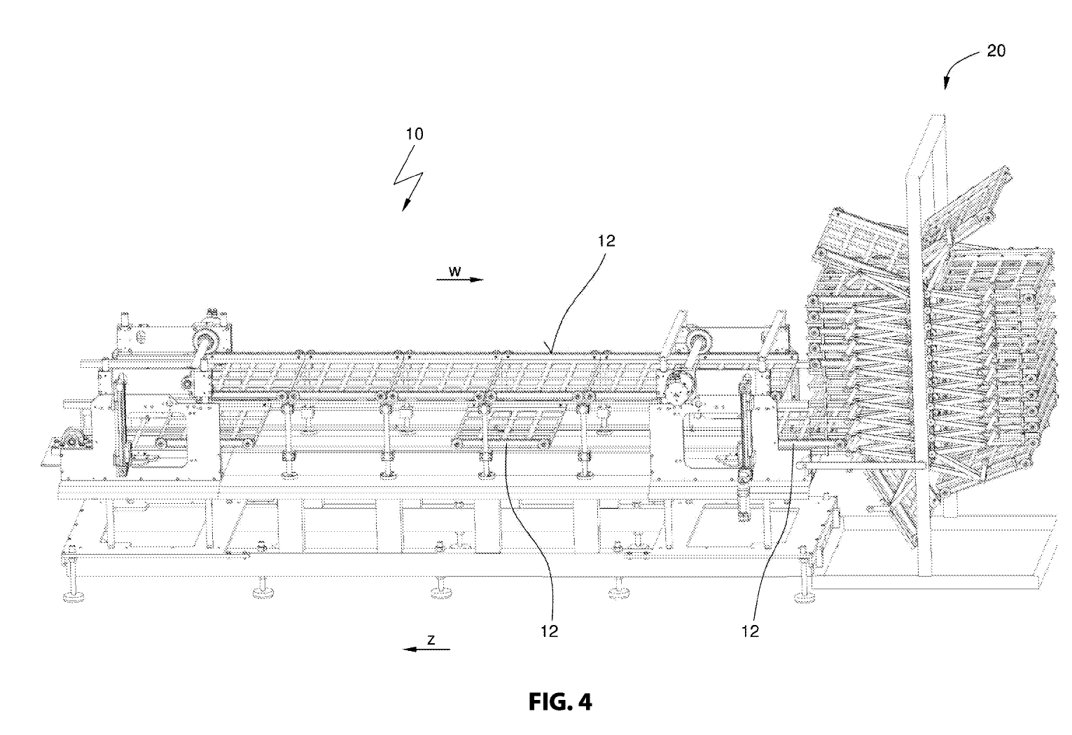

The function of the positioning members 23 and the of coupling members 26 can be derived from FIGS. 3 and 4. In FIGS. 3 and 4 the magazine 20 is arranged in its coupling position. In this coupling position the positioning members 23 of the magazine 20 and of the device 10 engage one another in that the positioning pins 24 engage the positioning recesses 25 so that the magazine 20 is correctly arranged with respect to the device 10.

In FIG. 4 furthermore the coupling members 26 of the magazine 20 and of the device 10 are in engagement. For this purpose, the locking bar 27 is pivoted in a direction towards the locking pin 29 until the locking bar recess 28 captures the locking pin 29 so that a locally fixated arrangement of the magazine 20 at the device 10 is provided.

The magazine 20 includes a plurality of insertion elements 30 in which support elements 12 can be stored. The insertion elements 30 are moveable in a linear manner at least in vertical direction x upward and in vertical direction y downward respectively along the magazine supports 22. In the present embodiment the insertion elements 30 are supported along the magazine supports 22 like a paternoster elevator. This means that the insertion elements 30 are supported in vertical direction x upward at a side of the magazine 20 that is in front of the device 10. At the end point of the vertical movement x, there is a reversal along which the insertion elements 30 are moved in a semicircular arc to a side of the magazine 20 that is on the back of the device 10 so that the insertion elements are supported in vertical direction y downward at this location. At the lower end of the vertical movement y, another reversal is performed which moves the insertion elements 30 back to the front side of the magazine 20.

The insertion elements 30 are arranged in the magazine 20 so that they are rotatable or pivotable about an axis S and can be moved about this axis S by up to 360°.

In the present embodiment it is provided that the rotatability or pivotability of the insertion elements 30 is used in the portion of the reversals in order to respectively reverse the insertion elements by 180°. This means in the context of the embodiment, that the insertion elements 30 or the support elements 12 supported in the insertion elements 30 are moved in vertical direction x with their topsides forward in the front magazine portion. In the portion of the upper reversal they are pivoted by 180° so that they are moved in the rear portion of the magazine 20 with their topsides forward in vertical direction y downward. In the lower reversal, a reversal movement of 180° is performed so that the topside of the respective support element 12 is oriented again in vertical direction x upward. The topside of the support elements 12 or of the insertion elements 30 is thus always oriented in the respective movement direction x or y in this embodiment.

The rotation or pivot movement of the insertion element 30 is controlled by a control curve or slotted control link which is part of the magazine 20 and can be arranged at one of the two magazine supports 22.

In order to prevent that the support elements 12 disengage from the insertion elements 30 through reversing the insertion elements 30, non-illustrated retaining elements are provided at the insertion elements 30, wherein the non-illustrated retaining elements fixate the support elements 12 at this location.

The insertion elements 30 include running bar sections 31 which correspond in type and form to the running bars of upper element OT or lower element UT and quasi represent shortening sections thereof.

In order to perform a format change of the device 10, the magazine 20 is fixated at the device 10 as illustrated in FIG. 4. A respective insertion element 30 is positioned in the plane of the lower element UT or of the upper element OT, wherein the insertion element 30 oriented towards the lower element UT includes a support element 12, whereas the insertion element 30 positioned towards the upper element OT is clear. The support element 12 is transferred from the insertion element 30 arranged in the plane of the lower element UT to the feed device of the lower element UT by hand or through an ejection device and thus integrated into the lower element UT. Simultaneously a support element 12 arranged in the upper element of the device 10 is moved into the free insertion element 30 positioned in the plane of the upper element OT. For this purpose, the magazine 20 can include a pull in device which supports this process.

Integrating new support elements 12 into the lower element UT is performed in feed direction z. Removing support elements 12 from the upper element OT is performed in feed direction w. Subsequently the movement in x/y direction commences and the next insertion element 30 that is provided with a support element 12 is positioned by the x/y movement in the plane of the lower element UT which causes a positioning of a free insertion element 30 in the plane of the upper element OT. Now in turn a new support element 12 is integrated into the lower element UT, wherein a support element 12 that is arranged in the upper element OT can be removed simultaneously or with a time delay when required. This process is repeated until the support elements 12 of one format are replaced with support elements 12 of another format.

Certainly introducing and removing support elements 12 is not necessarily coupled. It is feasible to initially remove a number of support elements and to only feed support elements 12 to the device 10 thereafter. By the same token, a number of support elements 12 can be inserted first, provided that there is space in one of the elements UT, OT, before removing support elements 12. Precise timing of insertion and removal depends from the specific configuration of the device.

It is provided that the magazine 20 and the device 10 have signal coupling for control signals and/or energy coupling. Thus, control conductors and energy conductors from the device 10 can be coupled to the magazine 20 so that the magazine 20 is controlled by the control of the device 10 and is fed with energy through the energy supply of the device 10 for operating the paternoster elevator type cycle and for controlling the optionally provided ejection and pull-in devices.

It is furthermore visible in the FIGs. that each insertion element 30 includes spacers 32 through which the insertion elements 30 are supported at one another and which support correct positioning of the insertion elements 30 with respect to upper element OT and lower element UT. In a paternoster type movement it can be necessary and useful that the spacer elements and the associated insertion element 30 are movement coupled with respect to the rotation and pivot movement. This is advantageous in particular when the rotation or pivot movement in the lower reversal is opposite to the rotation or pivot movement in the upper reversal.

The invention advantageously facilitates to perform a fast format change in a device 10 for the filling of containers with food products. The invention is advantageously suitable for devices with a chainless drive in which the individual support elements 12 can namely form an interconnection, but are not affixed to a common feed device. The device, according to WO 2011/072628 A1 of the applicant, is particularly advantageous for format changes with the described magazine, since the upper element OT and the lower element UT are freely accessible from the front side, this means in and/or against the feed direction w/z, and the insertion elements 30 can be directly coupled to the upper and lower elements OT and UT in their respective planes without any previous disassembly of device components.

However, other devices with chainless drives are also well suited for the described magazine, even when the transfer of the support elements 12 from the upper element OT into the lower element UT is performed differently during filling operations than in the applicant's WO 2011/072628 A1. In this case, the transfer devices would advantageously be affixed at the device with quick coupling connectors so that they are easily removable for the format change. After disassembly of the transfer devices, the magazine according to the invention can also be affixed to such devices as described.

### REFERENCE NUMERALS AND DESIGNATIONS

10 device for filling containers
11 container
12 support element
13 drive
14 brake device
15 lifting device
20 magazine
21 support frame
22 magazine support
23 positioning member
24 positioning pin
25 positioning recess
26 coupling member
27 locking bar
28 locking bar recess
29 locking pin
30 insertion element
31 running bar section
32 spacer
S axis
x vertical direction
y vertical direction
w feed direction
z feed direction
OT upper element
UT lower element
ST side element

What is claimed is:

1. A device for filling containers with low viscosity to pasty food products, the device comprising:
support elements that are run in a feed direction along an upper element, a first side element, a lower element and a second side element through the device in an endless manner,
wherein the support elements are run through the device in a chainless manner,
wherein the support elements are moved by a feed device between the upper element and the lower element,
wherein the support elements include receivers for containers,
wherein the containers are supported in the support elements along operating stations,
wherein a magazine is arrangeable at least at one of the side elements and the magazine is used for introducing additional support elements from the magazine into the device and/or for receiving support elements arranged in the device.

2. The device according to claim 1, wherein the magazine includes first positioning members which interact with second positioning members at the device in order to provide a correctly aligned arrangement of the magazine at the device.

3. The device according to claim 1, wherein the magazine and the device respectively include coupling members that cooperate with one another and provide an arrangement of the magazine that is fixated at the device.

4. The device according to claim 1, wherein the magazine includes insertion elements for receiving or removing individual support elements.

5. The device according to claim 1, wherein the insertion elements are arranged in the magazine in a vertically movable manner.

6. The device according to claim 1, wherein the insertion elements are supported at a vertically oriented magazine support like a paternoster elevator.

7. The device according to claim 1, wherein the insertion elements or the support elements are supported in the magazine in a pivotable or rotatable manner.

8. The device according to claim 6,
wherein the insertion elements or the support elements are supported in the magazine in a pivotable or rotatable manner,
wherein the insertion elements or the support elements seated in the insertion elements are respectively rotated or pivoted by 180° through a rotation or pivot movement in an upper reversal and a lower reversal.

9. The device according to claim 8, wherein the magazine includes a control curve or control coulisse controlling the rotation or pivot movement.

10. The device according to claim 1, wherein the magazine includes an ejection or pull-in device through which the support elements are transferable to the device or removable from the device.

11. The device according to claim 1, wherein the magazine and the device have signal coupling for control signals or energy coupling so that supplying the magazine with energy or r control signals is performed by the device.

12. The device according to claim 4, wherein the insertion elements include retaining elements for fixating the support elements in place.

13. The device according to claim 4, wherein the insertion elements are configured with sections of running bars that are identical to running bars on which the support elements are run through the upper element or the lower element.

14. The device according to claim 4, wherein the insertion elements are respectively provided with at least one spacer through which they are respectively supported at an adjacent insertion element.

15. The device according to claim 7,
wherein the insertion elements are respectively provided with at least one spacer through which they are respectively supported at an adjacent insertion element,
wherein the spacer and the insertion element are movement coupled with one another at least with respect to the rotation and pivot movement.

16. The device according to claim 8, wherein the rotation or pivot movement of the insertion element or of the support element in the lower reversal are opposite to the rotation or pivot movement in the upper reversal.

17. The device according to claim 1, wherein the magazine includes insertion elements for receiving and removing individual support elements.

18. The device according to claim 1, wherein the insertion elements and the support elements are supported in the magazine in a pivotable or rotatable manner.

19. The device according to claim 1, wherein the magazine includes an ejection and pull-in device through which the support elements are transferable to the device or removable from the device.

20. The device according to claim 1, wherein the magazine and the device have signal coupling for control signals and energy coupling so that supplying the magazine with energy and control signals is performed by the device.

21. The device according to claim 4, wherein the insertion elements are configured with sections of running bars that are identical to running bars on which the support elements are run through the upper element and the lower element.

22. The device according to claim 8, wherein the rotation or pivot movement of the insertion element and of the support element in the lower reversal are opposite to the rotation or pivot movement in the upper reversal.
